(19) United States
(12) Patent Application Publication
(10) Pub. No.: US 2004/0205988 A1
(43) Pub. Date: Oct. 21, 2004

(54) Light card

(76) Inventors: Karsten Kohler, Ettlingen (DE); Kurt Kohler, Ettlingen (DE)

Correspondence Address: KLAUS J. BACH, 4407 TWIN OAKS DRIVE, MURRYSVILLE, PA, 15668, US

(21) Appl. No.: 10/824,559

(22) Filed: Apr. 14, 2004

(30) Foreign Application Priority Data
Apr. 16, 2003 (DE) 103 17 467.2

(51) Int. Cl. G09F 1/00

(52) U.S. Cl. 40/124.02

(57) ABSTRACT

In a light card comprising a base and at least one light emitting element disposed on the base, a cover layer is provided which consists of a light permeable foil which, except for a light permeable area, is imprinted by a light impermeable coloring agent.

### BACKGROUND OF THE INVENTION

The invention relates to a light card which includes a light emitting element and a cover sheet with a transparent area.

Such a light card is known for example from DE 202 14 732 U1. This known light card includes a cover sheet or layer of an essentially opaque material with a light transparent area. The light transparent area is formed by a cut-out, which is covered by a transparent foil. This however is disadvantageous since the transparent area formed in this way is sensitive and is difficult and relatively expensive to manufacture.

In order to provide for a uniform area lighting of the transparent section a light emitting diode is arranged at a side of the transparent section. In this way, it is to be avoided that the transparent section is illuminated in a point-like manner. However, this object is achieved only in an unsatisfactory manner.

For improving the area illumination of the transparent section, it is therefore proposed that a layer of a dull reflective material is disposed between the light emitting diode and the transparent section. In this way, the illumination becomes more uniform but at the same time the brightness suffers.

It is the object of the present invention to provide a light card of the type as described above which however is easy to manufacture and includes a rugged transparent area with a good uniform back illumination.

### SUMMARY OF THE INVENTION

In a light card comprising a base and at least one light emitting element disposed on the base, a cover layer consisting of a light permeable foil is provided which, except for a light permeable area, is imprinted by a light impermeable coloring agent.

Since the cover layer is a foil extending over the full area of the card and imprinted with an opaque paint except for the desired transparent areas, it is not necessary to provide any cut-outs and there are no edges on the top surface so that the chances for that area to be damaged are very small as the cover layer, which may be for example a continuous plastic foil, has a smooth top surface.

Since the light transparent area is generated in that a transparent foil is provided by imprinting a transparent foil in selected areas with an opaque paint, the transparent area can be established in a simple inexpensive way. Only a particular area of the transparent foil needs to be rendered opaque by imprinting it. It is furthermore possible to provide a complex filigree pattern that is a fancy light pattern on the card surface. The limits for the configuration of the light transparent area is determined only by the limits of the printing techniques. Illuminated and non-illuminated or colored areas can be formed in a simple manner without mechanical cutouts and they can be provided in a continuous manner or interrupted manner for providing multiple attractive motives.

It is very advantageous if the cover sheet is imprinted only at the bottom side thereof. This eliminates the possibility that the paint layer is scratched or worn. Preferably, the print is applied in a layered fashion wherein a first imprint layer with a multicolor light transparent print is applied which forms the main motive of the light card. The color intensity may vary in the light transparent area. On top of the first imprint layer, a thin layer of a white color may be applied whereby the dispersion of the light from the light emitting element is improved.

Another layer of an opaque agent is then applied in the non-transparent areas as a negative imprint. This layer may be reflective, for example, glossy silvery. In this way, also complicated motives can be represented vividly. For example faces with color shadings, art motives, a heart with red color shadings or a moon with visible surface structures can be made visible. This is very advantageous as far as the valuation of the light card is concerned but does not increase the manufacturing costs.

Although the light emitting elements may basically be of any type and shape, light-emitting diodes have been found to be very advantageous. On one hand, light-emitting diodes (LED) are commercially available in suitable sizes and on the other hand, they generate light of high intensity.

Preferably, as light emitting element, a white light emitting diode is used. This permits the representation of multicolor images. In this way, not only single colored motives but motives in all colors and color shadings can be provided. The transparent area however may also be imprinted by a so-called Bright Sign Color wherein the light emitting element should then be an ultraviolet light emitting diode. In this way, a very attractive light permeable area can also be generated.

An embodiment of the invention wherein an intermediate layer is provided which has cut-outs in which the light emitting elements, a power supply and an operating element are arranged has been found to be very advantageous. With such an intermediate layer, which preferably consists of foamed rubber, on one hand the elements disposed on the base layer are protected from being damaged. On the other hand, the elements disposed on the base layer can be fixed in their positions by the intermediate layer. In addition, the intermediate layer has a stabilizing effect.

For improving the backlighting of the light transparent area, below the light transparent area, side delimiting parts of a material with high light reflectivity such as white plastic or white paper may be provided. It is very advantageous to use an oblong or square element of foam rubber which, at one side is provided with a self-adhesive coating. It has been found that such an element has good reflective properties whereby a very good backlighting of the transparent area is achieved. With the self-adhesive surface at one side, the element can further be attached to the base layer in a very simple and inexpensive manner. With such side delimiting parts below the lighted area, essentially a space is formed into which the light emitting element shines. It is particularly advantageous if the side delimiting parts are disposed such that they follow the contour of the light transparent area. In this way, the light transparent area is optimally uniformly illuminated. The backlighting of the light transparent area corresponds about to the brightness of light emitting EL foils or acrylic glass plates into which light is radiated from the sides thereof. But the arrangement according to the invention is simpler and can be manufactured at substantially lower costs.

In addition to the light emitting elements and with the arrangement described above by which backlighting of the transparent area is achieved a light scattering element or light scattering elements may be provided.

It is particularly advantageous if the light-emitting elements are connected to the base layer. It is furthermore advantageous if the base layer, the intermediate layer and the cover layer are cemented together. Such an arrangement can be manufactured relatively inexpensively and has a high strength.

The light card according to the invention may have a connection for an external power supply. Then the light card may be used for example commercially as a decoration object. The light card may be placed for example onto a shelf or it may be used by means of a mechanical holder, as a “light card lamp”. The light card according to the invention may still be used after exhaustion of the batteries installed in the card and accordingly represents for the owner a durable value.

Further details, features and advantages will become more readily apparent from the following description of a particular embodiment thereof on the basis of the accompanying drawings.

### BRIEF DESCRIPTION OF THE DRAWINGS

FIG. 1 shows a light card without cover layer,

FIG. 2 shows a cover layer, and

FIG. 3 is a side view of the light card and according to the invention.

### DESCRIPTION OF A PREFERRED EMBODIMENT

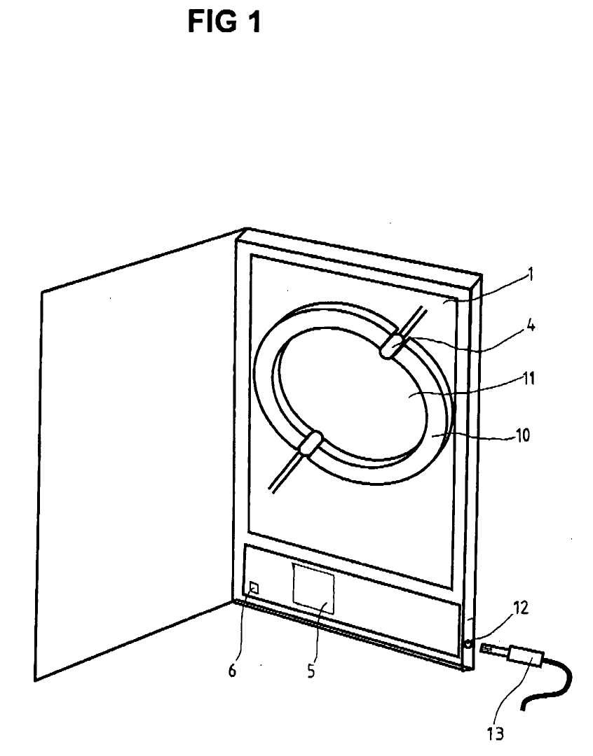

As apparent from FIG. 1, on the base layer 1 which consists of a cardboard of about 1 mm thickness and has a surface —which is at least partially light reflective, light emitting elements 4 in the form of light emitting diodes 4 (LED) are arranged. The LEDs are flat and are cemented onto the base layer 1. Furthermore, a power supply 5 and, if needed, an electronic control structure are cemented onto the base layer 1. The electronic control structure and the power supply may be arranged on a very thin conductor plate. Further, a switch 6 is disposed on the base layer 1 for energizing the LEDs. The LEDs 4 may be mounted onto the base layer 1 by means of glue pads.

The LEDs 4 are divided into two groups, wherein the LEDs 4 of each group are interconnected and each group is connected to the power supply 5 or, respectively, the electronic control structure. The switch 6 is in communication with the electronic control structure or respectively the power supply 5 by way of conductors 5c.

The light card further includes a connector 12 by way of which the light card can be supplied with energy. To this end, a plug 13 is inserted into the connector 12, which plug is connected to a power supply not shown in FIG. 1.

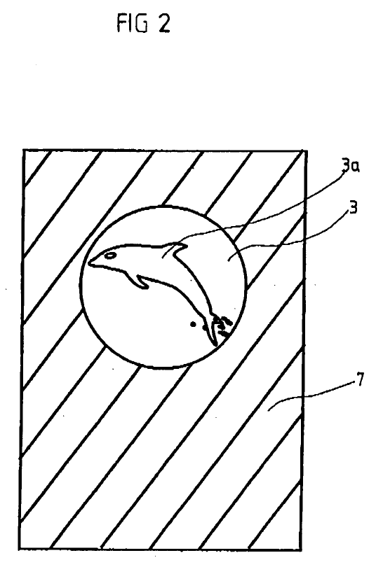

As shown in FIG. 2, the cover layer 2, which consists of an about 1 mm thick light transmissible plastic foil includes a transparent area 3, 3a and an opaque area 7. The transparent area 3, 3a is imprinted by a light transmissible coloring agent of different intensities. For example, a part 3 of the light transmissible area which forms a background has a relatively low color intensity so that, with backlighting, it appears light. By varying the intensity or by using different color components, the background may be made to look very attractive. A second part 3a of the light permeable area which represents for example a motive may be imprinted by higher intensity. In this way, the motive is distinguished from the background in an attractive way.

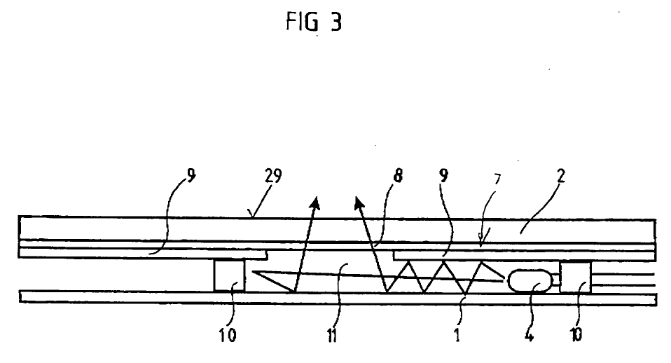

As apparent from FIG. 3, the cover layer 2 is imprinted fully by a layer 8 of a light permeable color. In the light impermeable area 7, a layer 9 of a light impermeable coloring agent is deposited on the light permeable layer 8. At its surface 2a opposite the color layers 8, 9, the cover layer 2 is roughened. This is advantageous for the light emission from the light permeable areas 3, 3a.

What is claimed is:

1. A light card, comprising a base (1) at least one light emitting element (4) disposed on said base (1) and a cover layer (2) having at least one light transparent area (7), said cover layer (2) consisting of a light permeable foil which, except for the light transparent area (7), is imprinted by a coloring agent which is impermeable to light.

2. A light card according to claim 1, wherein the light transparent area (7) is imprinted by a bright sign coloring agent and the light emitting element (4) is an ultraviolet light emitting diode.

3. A light card according to claim 1, wherein said foil is imprinted on the side thereof facing said base (1).

4. A light card according to claim 1, wherein said cover layer comprises a foil (2), which is roughened at the side thereof facing away from said base (1).

5. A light card according to claim 1, wherein an intermediate layer (3) is disposed between said base (1) and said cover layer (2), said intermediate layer (3) having recesses, in which said light emitting elements (4), said power supply (5) and an operating element (6) are disposed.

6. A light card according to claim 5, wherein said intermediate layer (3) consists of foam rubber.

7. A light card according to claim 1, wherein said light emitting elements (4) are cemented onto said base (1).

8. A light card according to claim 5, wherein said base (1), said intermediate layer (3) and said cover layer (2) are cemented together.

9. A light card according to claim 1, wherein highly reflective side limit areas are arranged on said base (1) below the light permeable areas.

10. A light card according to claim 1, wherein a connection for an external power supply is provided.
